(19) United States
(12) Patent Application Publication
(10) Pub. No.: US 2026/0044284 A1
(43) Pub. Date: Feb. 12, 2026

(54) MEMORY SYSTEMS AND OPERATION METHODS THEREOF, SYSTEMS, AND STORAGE MEDIUMS

(71) Applicant: YANGTZE MEMORY TECHNOLOGIES CO., LTD., Wuhan (CN)

(72) Inventors: Yuetan WANG, Wuhan (CN); Yue MA, Wuhan (CN); Kaiyao CAO, Wuhan (CN)

(21) Appl. No.: 19/013,810

(22) Filed: Jan. 8, 2025

(30) Foreign Application Priority Data
Aug. 6, 2024 (CN) 2024110752484

(51) Int. Cl. G06F 3/06

(52) U.S. Cl. CPC G06F 3/0659; G06F 3/0611; G06F 3/0653; G06F 3/0679

(57) ABSTRACT

Examples of the present disclosure provide memory systems and operation methods thereof, systems, and storage mediums. An example memory system includes a memory and a memory controller coupled with the memory. The memory controller is configured to control the memory to achieve zoned storage by zone, wherein a storage space of a single zone is configured to support sequential write; wherein the memory controller is configured with a first interface coupled with a host and to receive a first command from the host through the first interface, wherein the first command includes MODE RETURN information indicating whether MEMORY MODE information of the zone needs to be returned; and the memory controller is further configured to send REPORT ZONES parameter data satisfying what the MODE RETURN information indicates to the host through the first interface according to the first command.

### CROSS-REFERENCE TO RELATED APPLICATIONS

The present application claims priority to Chinese Patent Application No. 2024110752484, which was filed Aug. 6, 2024, and is hereby incorporated herein by reference in its entirety.

### TECHNICAL FIELD

Examples of the present disclosure relate to the field of semiconductor technology, and in particular, to a memory system and an operation method thereof, a system, and a storage medium.

### BACKGROUND

A memory system may comprise one or more memories for storing data. The memory may be a memory supporting a zone name space (ZNS).

### SUMMARY

Examples of the present disclosure provide a memory system and an operation method thereof, a system, and a storage medium.

In a first aspect, examples of the present disclosure provide a memory system, comprising: a memory and a memory controller coupled with the memory, wherein the memory controller is configured to control the memory to achieve zoned storage by zone, wherein a storage space of a single zone is configured to support sequential write; wherein the memory controller is configured with a first interface coupled with a host and to receive a first command from the host through the first interface; the first command comprises MODE RETURN information indicating whether MEMORY MODE information of the zone needs to be returned; and the memory controller is further configured to send REPORT ZONES parameter data satisfying what the MODE RETURN information indicates to the host through the first interface according to the first command.

In some examples, the memory controller is configured to: in cases the MODE RETURN information is configured to indicate that the MEMORY MODE information of the zone needs to be returned, generate the REPORT ZONES parameter data comprising the MEMORY MODE information according to the first command.

In some examples, the MEMORY MODE information is configured to indicate MEMORY MODE of the zone; the MEMORY MODE comprises a first MEMORY MODE and a second MEMORY MODE; when the zone is in the first MEMORY MODE, each of memory cells corresponding to the storage space of the zone can be written with N-bit data; when the zone is in the second MEMORY MODE, each of the memory cells corresponding to the storage space of the zone can be written with M-bit data; M and N are integers greater than or equal to 1; and M is greater than N.

In some examples, the MEMORY MODE information is in a zone descriptor in the REPORT ZONES parameter data.

In some examples, the REPORT ZONES parameter data comprises a zone descriptor list and a public descriptor; the zone descriptor list comprises at least one zone descriptor for indicating self attributes of a corresponding zone; and the public descriptor is configured to indicate a public attribute of a plurality of the zones.

In some examples, the MEMORY MODE information occupies a four-bit field in the zone descriptor.

In some examples, the zone descriptor further comprises a ZONE TYPE field, a ZONE CONDITION field, a ZONE LENGTH field, a ZONE START LBA field, and a WRITE POINT LBA field.

In some examples, the public descriptor comprises a ZONE LIST LENGTH field, a SAME field, and a MAXIMUM LBA field, etc.

In some examples, the first command comprises a REPORT ZONES command.

In some examples, the zone is in a zone name space (ZNS).

In a second aspect, examples of the present disclosure provide a system, comprising: a memory system and a host, wherein the memory system comprises: a memory and a memory controller coupled with the memory, wherein the memory controller is configured to control the memory to achieve zoned storage by zone, wherein a storage space of a single zone is configured to support sequential write; wherein the memory controller is configured with a first interface coupled with a host and to receive a first command from the host through the first interface; the host comprises a host controller and a second interface coupled with the memory controller; the host controller is configured to generate the first command and send the first command to the memory controller through the second interface; the first command comprises MODE RETURN information indicating whether MEMORY MODE information of the zone needs to be returned; and the memory controller is further configured to send REPORT ZONES parameter data satisfying what the MODE RETURN information indicates to the host through the first interface according to the first command.

In some examples, the memory controller is configured to: in cases the MODE RETURN information is configured to indicate that the MEMORY MODE information of the zone needs to be returned, generate the REPORT ZONES parameter data comprising the MEMORY MODE information according to the first command.

In some examples, the MEMORY MODE information is in a zone descriptor in the REPORT ZONES parameter data.

In some examples, the MEMORY MODE information is configured to indicate MEMORY MODE of the zone; the MEMORY MODE comprises a first MEMORY MODE and a second MEMORY MODE; when the zone is in the first MEMORY MODE, each of memory cells corresponding to the storage space of the zone can be written with N-bit data; when the zone is in the second MEMORY MODE, each of the memory cells corresponding to the storage space of the zone can be written with M-bit data; M and N are integers greater than or equal to 1; and M is greater than N.

In some examples, the host controller is configured to generate a corresponding zone write request according to cold and hot attributes of write data and send the write data and the zone write request to the memory controller through the second interface; if the write data is hot data, the zone write request is configured to indicate to write the write data into a zone where the MEMORY MODE is the first MEMORY MODE; and if the write data is non-hot data, the zone write request is configured to indicate to write the write data into a zone where the MEMORY MODE is the second MEMORY MODE; and the memory controller is configured to write the write data into a storage space of a corresponding zone according to the zone write request.

In some examples, the REPORT ZONES parameter data comprises a zone descriptor list and a public descriptor; the zone descriptor list comprises at least one zone descriptor; and the MEMORY MODE information uses a four-bit field in the zone descriptor.

In some examples, the first command comprises a REPORT ZONES command.

In some examples, the zone is in a zone name space (ZNS).

In a third aspect, examples of the present disclosure provide an operation method of a memory system. The method comprises: receiving a first command through the first interface, wherein the first command comprises MODE RETURN information for indicating whether MEMORY MODE information of a zone needs to be returned; and sending REPORT ZONES parameter data satisfying what the MODE RETURN information indicates through the first interface according to the first command.

In some examples, in cases the MODE RETURN information is configured to indicate that the MEMORY MODE information of the zone needs to be returned, sending the REPORT ZONES parameter data satisfying what the MODE RETURN information indicates through the first interface according to the first command comprises: generating the REPORT ZONES parameter data comprising the MEMORY MODE information according to the first command.

In some examples, the MEMORY MODE information is in a zone descriptor in the REPORT ZONES parameter data.

In some examples, the MEMORY MODE information is configured to indicate MEMORY MODE of the zone; the MEMORY MODE comprises a first MEMORY MODE and a second MEMORY MODE; when the zone is in the first MEMORY MODE, each of memory cells corresponding to the storage space of the zone can be written with N-bit data; when the zone is in the second MEMORY MODE, each of the memory cells corresponding to the storage space of the zone can be written with M-bit data; M and N are integers greater than or equal to 1; and M is greater than N.

In some examples, the REPORT ZONES parameter data comprises a zone descriptor list and a public descriptor; the zone descriptor list comprises at least one zone descriptor; and the MEMORY MODE information uses a four-bit field in the zone descriptor.

In some examples, the first command comprises a REPORT ZONES command.

In some examples, the zone is in a zone name space (ZNS).

In a fourth aspect, examples of the present disclosure provide a computer readable storage medium, storing a computer program thereon which, when executed, implements the method of the third aspect.

### BRIEF DESCRIPTION OF THE DRAWINGS

FIG. 1 is a schematic diagram of an example system having a memory system according to an example of the present disclosure.

FIG. 2A is a schematic diagram of an example memory card having a memory system according to an example of the present disclosure.

FIG. 2B is a schematic diagram of an example solid state drive having a memory system according to an example of the present disclosure.

FIG. 3A is a distribution schematic diagram of the memory cells of a three-dimensional NAND memory according to an example of the present disclosure.

FIG. 3B is a schematic diagram of an example memory device comprising a peripheral circuit according to an example of the present disclosure.

FIG. 4 is a schematic cross-sectional view of a memory cell array comprising a NAND memory string according to an example of the present disclosure.

FIG. 5A is a schematic diagram of an example memory device comprising a memory cell array and a peripheral circuit according to an example of the present disclosure.

FIG. 5B is a schematic diagram of a memory controller provided by an example of the present disclosure.

FIG. 6 is a schematic structural diagram of a REPORT ZONES command among ZBCs provided by an example of the present disclosure.

FIG. 7A is a schematic structural diagram of REPORT ZONES parameter data in ZBCs provided by an example of the present disclosure.

FIG. 7B is a schematic structural diagram of a zone descriptor in REPORT ZONES parameter data provided by an example of the present disclosure.

FIG. 8 is a flow diagram of interaction between a memory system and a host provided by an example of the present disclosure.

FIG. 9 is a flow diagram of an operation method of a memory system provided by an example of the present disclosure.

### DETAILED DESCRIPTION

The technical solutions in implementations of the present disclosure will be described below in conjunction with the implementations and drawings of the present disclosure. Apparently, the described implementations are merely part, but not all, of the implementations of the present disclosure. All other implementations obtained by those of ordinary skills in the art based on the implementations in the present disclosure without creative work shall fall within the scope of protection of the present disclosure.

In the description below, many particular details are presented to provide a more thorough understanding of the present disclosure. However, it is apparent to those skilled in the art that the present disclosure may be practiced without one or more of these details. In other examples, in order to avoid confusion with the present disclosure, some technical features well-known in the field are not described. For example, not all the features of the actual implementations are described herein, and well-known functions and structures are not described in detail.

In the drawings, the sizes of a layer, a zone, and an element and their relative sizes may be exaggerated for clarity. Like reference numerals denote like elements throughout.

It is to be understood that when an element or a layer is referred to as being “on”, “adjacent to”, “connected to”, or “coupled to” other elements or layers, it may be directly on, adjacent to, connected to, or coupled to the other elements or layers, or one or more intervening elements or layers may be present. In contrast, when an element is referred to as being “directly on”, “immediately adjacent to”, “directly connected to”, or “directly coupled to” other elements or layers, no intervening elements or layers are present. It is to be understood that, although the terms first, second, third, etc. may be used to describe various elements, components, zones, layers, and/or portions, these elements, components, zones, layers, and/or portions should not be limited by these terms. These terms are only used to distinguish one element, component, zone, layer or portion from another element, component, zone, layer or portion. Thus, a first element, component, zone, layer or portion discussed below may be denoted as a second element, component, zone, layer or portion, without departing from the teachings of the present disclosure. However, when a second element, component, zone, layer or portion is discussed, it does not mean that a first element, component, zone, layer or portion is necessarily present in the present disclosure.

The spatially relation terms, such as “beneath”, “below”, “lower”, “under”, “above”, “upper” and the like, may be used herein for case of description to describe a relationship of one element or feature with respect to another element or feature as illustrated in the figure. It is to be understood that, the spatially relation terms are intended to further encompass different orientations of a device in use or operation in addition to the orientation depicted in the figures. For example, if the device in the drawings is turned over, then the elements or the features described as “below” or “under” or “beneath” other elements may be oriented “on” the other elements or features. Therefore, the example terms “below” and “beneath” may comprise both upper and lower orientations. The device may be orientated otherwise (rotated by 90 degrees or in other orientations), and the spatially descriptive terms used herein are interpreted accordingly.

The terms used herein are intended to describe the particular examples only, and are not limitations to the present disclosure. As used herein, unless otherwise indicated expressly in the context, “a”, “an” and “the” in a singular form are also intended to comprise a plural form. It should also be understood that terms “consist of” and/or “comprise”, when used in this specification, determine the presence of the described features, integers, steps, operations, elements and/or components, but do not preclude the presence or addition of one or more other features, integers, steps, operations, elements, components, and/or groups. As used herein, the term “and/or” comprises any and all combinations of related items listed.

In order to understand the present disclosure thoroughly, detailed operations and detailed structures will be proposed in the following description to set forth the technical solutions of the present disclosure. Detailed descriptions of preferable examples of the present disclosure are as follows. However, the present disclosure may also have other implementations in addition to these

### DETAILED DESCRIPTIONS

A memory in examples of the present disclosure includes, but is not limited to, a three-dimensional NAND memory. For ease of understanding, the three-dimensional NAND memory is used as an example for description.

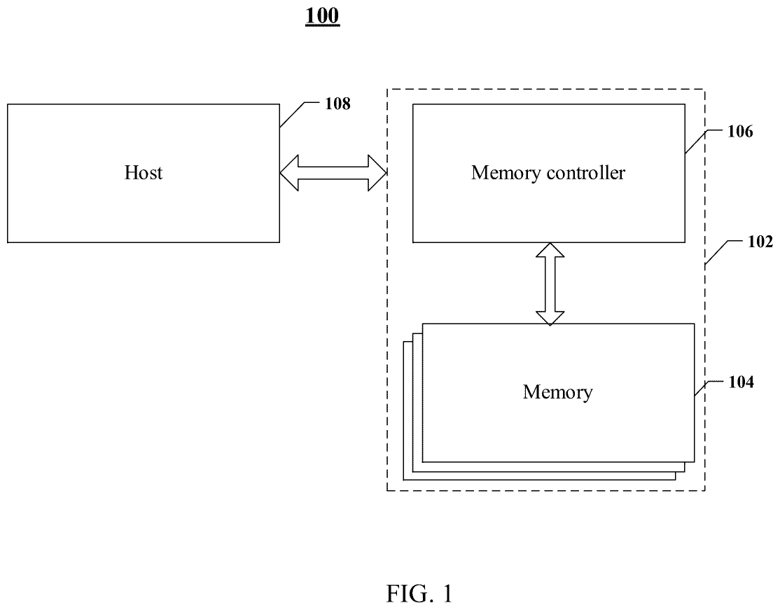

FIG. 1 is a block diagram of an example system 100 having a memory according to an example of the present disclosure. The system 100 may be a mobile phone, a desktop computer, a laptop computer, a tablet computer, a vehicle computer, a gaming console, a printer, a positioning apparatus, a wearable electronic apparatus, a smart sensor, a virtual reality (VR) apparatus, an augmented reality (AR) apparatus, or any other suitable electronic apparatuses having memories therein. As shown in FIG. 1, the system 100 may comprise a host 108 and a memory system 102, where the memory system 102 has one or more memories 104 and a memory controller 106. The host 108 may be a processor (e.g., a central processing unit (CPU)) or a system on chip (SOC) (e.g., an application processor (AP)) of an electronic apparatus. The host 108 may be configured to send data to or receive data from the memory 104. The host 108 comprises a host controller and a second interface coupled with the memory controller 106. For example, the second interface may also be an interface for the host to communicate with the memory controller.

In some implementations, the memory controller 106 is coupled to the memory 104 and the host 108, and is configured to control the memory 104. The memory controller 106 may manage data stored in the memory 104, and communicate with the host 108. In some implementations, the memory controller 106 is designed for operating in a low duty-cycle environment, such as secure digital (SD) cards, compact flash (CF) cards, universal serial bus (USB) flash drives, or other media for use in electronic apparatuses, such as personal computers, digital cameras, mobile phones, etc. In some implementations, the memory controller 106 is designed for operating in a high duty-cycle environment of SSDs or embedded multimedia cards (eMMCs) used as data memories for mobile apparatuses, such as smartphones, tablets, laptop computers, etc., and enterprise memory arrays.

The memory controller 106 may be configured to control operations of the memory 104, such as read, erase, and program operations. The memory controller 106 may further be configured to manage various functions with respect to data stored or to be stored in the memory 104, including, but not limited to, bad-block management, garbage collection, logical-to-physical address translation, wear leveling, etc. In some implementations, the memory controller 106 is further configured to process error correction codes (ECCs) with respect to data read from or written to the memory 104. The memory controller 106 may further perform any other suitable functions, for example, formatting the memory 104. The memory controller 106 may communicate with an external apparatus (e.g., the host 108) according to a specific communication protocol. For example, the memory controller 106 may communicate with the external apparatus through at least one of various interface protocols, such as a USB protocol, an MMC protocol, a Peripheral Component Interconnection (PCI) protocol, a PCI-Express (PCI-E) protocol, an Advanced Technology Attachment (ATA) protocol, a Serial-ATA protocol, a Parallel-ATA protocol, a Small Computer Small Interface (SCSI) protocol, an Enhanced Small Disk Interface (ESDI) protocol, an Integrated Drive Electronics (IDE) protocol, and a Firewire protocol, etc. These interfaces may also be referred as first interfaces (also called front end interfaces). Here, the first interfaces are interfaces coupled with the second interface of the host described above. In some examples, the memory controller 106 interacts with the memory 104 for commands/data through a plurality of configured channels. These channels are also referred to as back end interfaces.

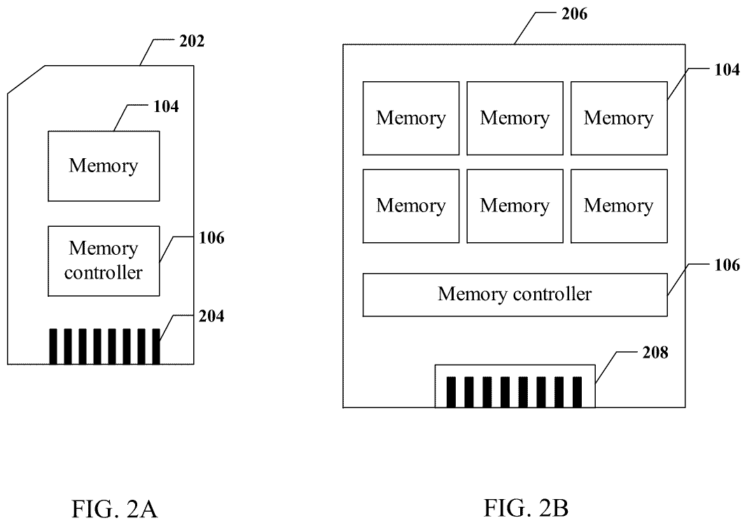

The memory controller 106 and the one or more memories 104 may be integrated into various types of storage apparatuses, for example, be comprised in the same package (such as a universal flash storage (UFS) package or an eMMC package). For example, the memory system 102 may be implemented and packaged into different types of end electronic products. In one example shown in FIG. 2A, the memory controller 106 and the single memory 104 may be integrated into a memory card 202. The memory card 202 may include a PC card (Personal Computer Memory Card International Association (PCMCIA)), a CF card, a Smart Media (SM) card, a memory stick, a multimedia card (MMC, RS-MMC, MMCmicro), an SD card (SD, miniSD, microSD, SDHC), and a UFS, etc. The memory card 202 may further comprise a memory card connector 204 coupling the memory card 202 with a host (e.g., the host 108 in FIG. 1). In another example shown in FIG. 2B, the memory controller 106 and the plurality of memories 104 may be integrated into an SSD 206. The SSD 206 may further comprise an SSD connector 208 coupling the SSD 206 with a host (e.g., the host 108 in FIG. 1). In some implementations, storage capacity and/or operation speed of the SSD 206 is greater than storage capacity and/or operation speed of the memory card 202.

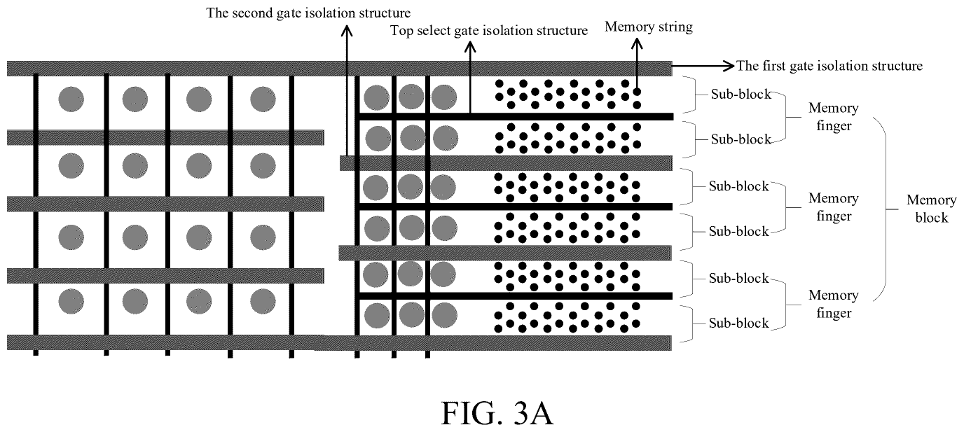

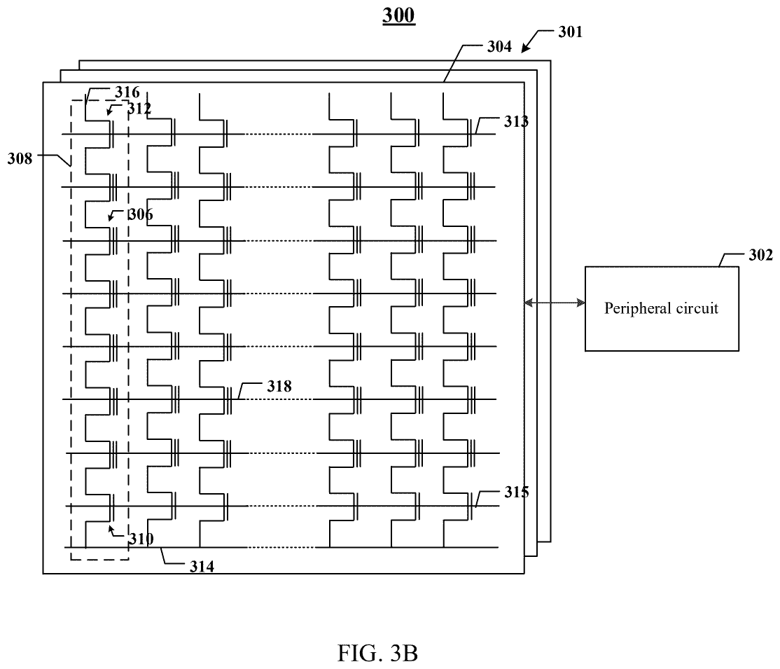

FIG. 3A is a schematic structural diagram of a memory cell array of a three-dimensional NAND memory according to an example of the present disclosure. As shown in FIG. 3A, the memory cell array of the three-dimensional NAND memory is composed of a number of memory cell rows that are staggered in parallel and parallel to gate isolation structures. Every two memory cell rows are spaced apart by a gate isolation structure and a top select gate isolation structure, and each memory cell row comprises a plurality of memory cell strings. The gate isolation structure may comprise a first gate isolation structure and a second gate isolation structure. The first gate isolation structure divides the memory cell array into a plurality of memory blocks. A plurality of second gate isolation structures may divide the memory blocks into a plurality of memory fingers. The top select gate isolation structure disposed in the middle of each memory finger may divide the memory finger into two portions, so as to divide the memory finger into two sub-blocks. One memory block shown in FIG. 3A comprises 6 sub-blocks. In practical application, the number of sub-blocks in one memory block is not limited thereto.

It should be noted that the number of memory cell rows between the gate isolation structure and the top select gate isolation structure shown in FIG. 3A is only an example illustration, and is not used to limit the number of memory cell rows included in one finger memory zone of the three-dimensional NAND memory in the present disclosure. In practical applications, the number of memory cell rows included in one finger memory zone may be adjusted to, for example, 2, 4, 8, and 16, etc., according to practical situations.

FIG. 3B is a schematic circuit diagram of an example memory 300 comprising a peripheral circuit 302 according to an example of the present disclosure. The memory 300 may be an example of the memory 104 in FIG. 1. The memory 300 may comprise a memory cell array 301 and a peripheral circuit 302 coupled to the memory cell array 301. The memory cell array 301 as being a three-dimensional NAND memory cell array is illustrated as an example, where memory cells 306 are provided in an array of NAND memory strings 308, and each NAND memory string 308 extends vertically above a substrate (not shown). In some implementations, each NAND memory string 308 comprises a plurality of memory cells 306 coupled in series and stacked vertically. Each memory cell 306 may hold a continuous analog value, such as voltage or charge, which depends on the number of electrons trapped in a zone of the memory cell 306. Each memory cell 306 may be a floating gate type memory cell that comprises a floating gate transistor, or a charge trap type memory cell that comprises a charge trap transistor.

In some implementations, each memory cell 306 comprises a Single Level Cell (SLC) that has two possible memory states and thus can store one bit of data. For example, a first memory state “0” may correspond to a first voltage range, and a second memory state “1” may correspond to a second voltage range. In some implementations, each memory cell 306 comprises a Multi Level Cell (MLC) that is capable of storing more than a single bit of data in more than four memory states. For example, the MLC may store two bits per cell, three bits per cell (also referred to as a Triple Level Cell (TLC)), or four bits per cell (also referred to as a Quad Level Cell (QLC)). Each MLC can be programmed to adopt a range of possible nominal memory values. In one example, if each MLC stores two bits of data, the MLC can be programmed to adopt one of three possible program levels from an erase state by writing one of three possible nominal storage values to the cell. A fourth nominal storage value may be configured for the erase state.

As shown in FIG. 3B, each NAND memory string 308 may comprise a bottom select gate (BSG) 310 at its source terminal and a top select gate (TSG) 312 at its drain terminal. The BSG 310 and the TSG 312 may be configured to activate a selected NAND memory string 308 during read and program operations. In some implementations, sources of the NAND memory strings 308 in the same memory block 304 are coupled through the same source line (SL) 314 (e.g., a common SL). For example, according to some implementations, all the NAND memory strings 308 in the same memory block 304 have an array common source (ACS). According to some implementations, the TSG 312 of each NAND memory string 308 is coupled to a respective bit line (BL) 316, and data may be read or written from the bit line 316 via an output bus (not shown). In some implementations, each NAND memory string 308 is configured to be selected or unselected by applying a select voltage (e.g., greater than a threshold voltage of a transistor having the TSG 312) or an unselect voltage (e.g., 0 V) to the respective TSG 312 via one or more TSG lines 313 and/or by applying a select voltage (e.g., greater than a threshold voltage of a transistor having the BSG 310) or an unselect voltage (e.g., 0 V) to the respective BSG 310 via one or more BSG lines 315.

As shown in FIG. 3B, the NAND memory strings 308 can be organized into a plurality of memory blocks 304, and each of the memory blocks 304 may have a common source line 314 (e.g., coupled to the ground). In some implementations, each memory block 304 is a basic data unit for the erase operation, e.g., all the memory cells 306 on the same memory block 304 are erased at the same time. In order to erase the memory cells 306 in a selected memory block, the source lines 314 coupled to the selected memory block and unselected memory blocks that are in the same plane as the selected memory block can be biased with an erase voltage (Vers) (such as a high positive voltage (e.g., 20 V or higher)). It is to be understood that in some examples, the erase operation may be performed at a half memory block level, a quarter memory block level, or a level with any suitable count of memory blocks or any suitable fractions of a memory block. The memory cells 306 of adjacent NAND memory strings 308 may be coupled through word lines 318, and the word lines 318 select which row of memory cells 306 is affected by the read and program operations.

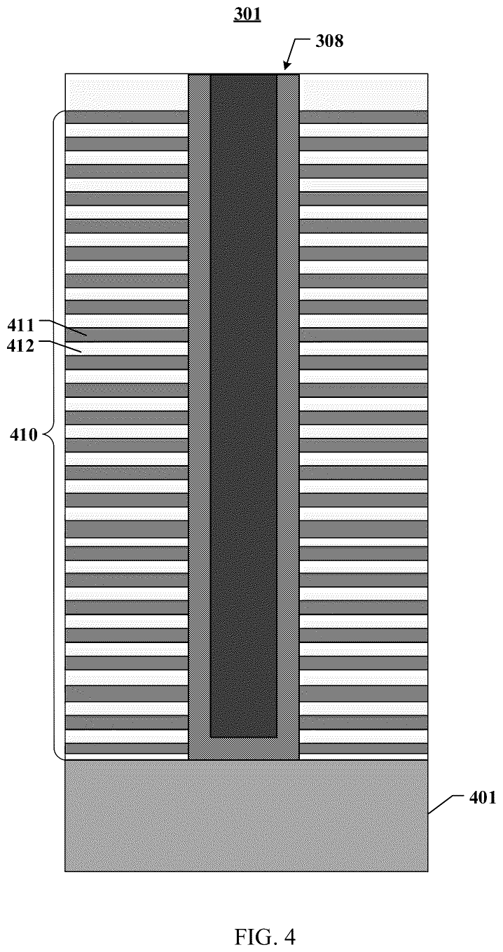

FIG. 4 is a schematic cross-sectional view of an example memory cell array 301 comprising a NAND memory string 308 according to an example of the present disclosure. As shown in FIG. 4, the NAND memory string 308 may comprise a stack structure 410 which comprises a plurality of gate layers 411 and a plurality of insulation layers 412 that are disposed as being stacked sequentially and alternately, and the memory string 308 penetrating through the gate layers 411 and the insulation layers 412 vertically. The gate layers 411 and the insulation layers 412 may be stacked alternately, and two adjacent gate layers 411 are spaced apart by one insulation layer 412. The number of pairs of the gate layer 411 and the insulation layer 412 in the stack structure 410 may determine the number of memory cells comprised in the memory cell array 301.

A composition material of the gate layers 411 may comprise a conductive material. The conductive material includes, but is not limited to, tungsten (W), cobalt (Co), copper (Cu), aluminum (Al), polysilicon, doped silicon, silicide, or any combination thereof. In some implementations, each gate layer 411 comprises a metal layer, e.g., a tungsten layer. In some implementations, each gate layer 411 comprises a doped polysilicon layer. Each gate layer 411 may comprise a control gate surrounding the memory cells. The gate layer 411 at the top of the stack structure 410 may extend laterally as a top select gate line; the gate layer 411 at the bottom of the stack structure 410 may extend laterally as a bottom select gate line; and the gate layers 411 that extend laterally between the top select gate line and the bottom select gate line may act as word line layers.

In some implementations, the stack structure 410 may be disposed on a semiconductor layer 401. The semiconductor layer 401 may comprise silicon (e.g., single crystalline silicon), silicon germanium (SiGe), gallium arsenide (GaAs), germanium (Ge), silicon on insulator (SOI), germanium on insulator (GOI), or any other suitable materials.

In some implementations, the NAND memory string 308 comprises a channel structure extending through the stack structure 410 vertically. In some implementations, the channel structure comprises a channel hole filled with (one or more) semiconductor materials (e.g., as a semiconductor channel) and (one or more) dielectric materials (e.g., as a memory film). In some implementations, the semiconductor channel includes silicon, e.g., polysilicon. In some implementations, the memory film is a composite dielectric layer comprising a tunneling layer, a storage layer (also referred to as a “charge trap/storage layer”), and a barrier layer. The channel structure may have a cylindrical shape (e.g., a pillar shape). According to some implementations, the semiconductor channel, the tunneling layer, the storage layer, and the barrier layer are arranged radially from the center of the pillar toward the outer surface of the pillar in this order. The tunneling layer may include silicon oxide, silicon oxynitride, or any combination thereof. The storage layer may comprise silicon nitride, silicon oxynitride, or any combination thereof. The barrier layer may include silicon oxide, silicon oxynitride, a high dielectric constant (high-k) dielectric, or any combination thereof. In an example, the memory film may comprise a composite layer of silicon oxide/silicon oxynitride/silicon oxide (ONO).

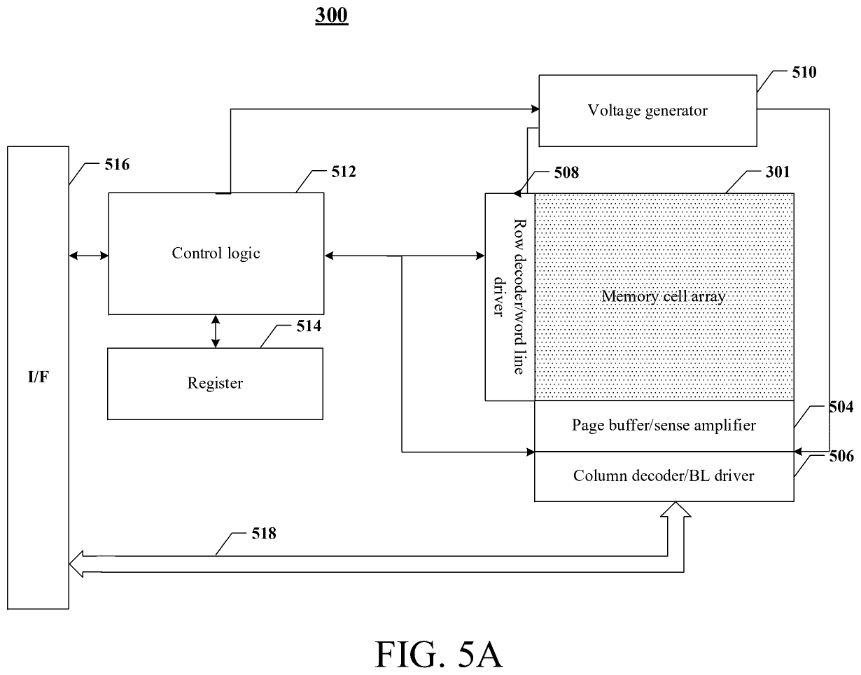

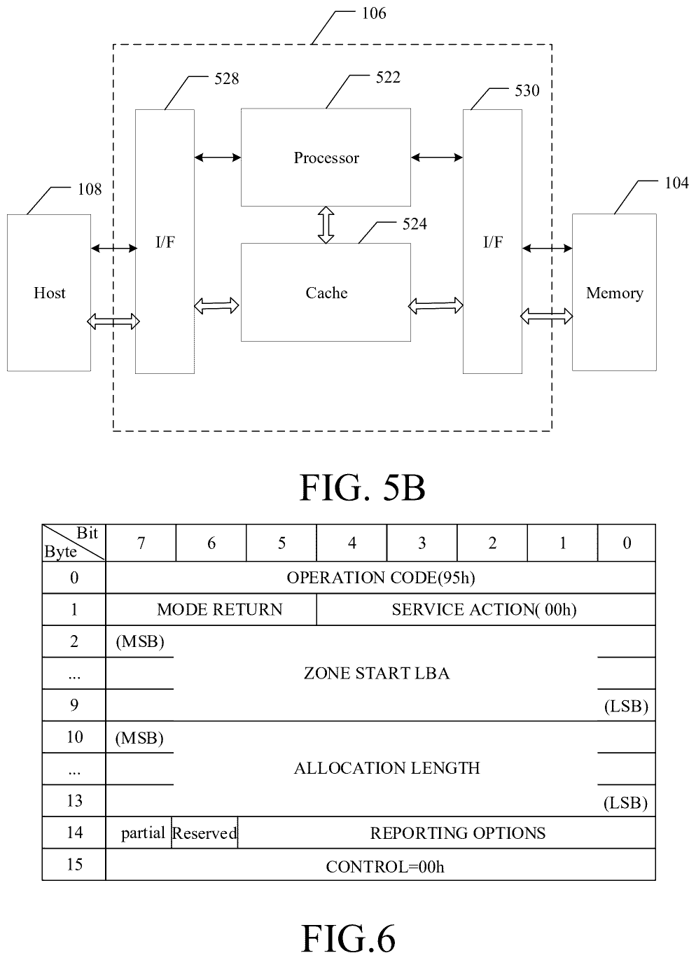

Referring back to FIG. 3B, the peripheral circuit 302 may be coupled to the memory cell array 301 through the bit lines 316, the word lines 318, the source lines 314, the BSG lines 315 and the TSG lines 313. The peripheral circuit 302 may comprise any suitable analog, digital, and hybrid signal circuits for facilitating operations of the memory cell array 301 by applying at least one of a voltage signal or a current signal to each target memory cell 306 and sensing at least one of a voltage signal or a current signal from each target memory cell 306 via the bit lines 316, the word lines 318, the source lines 314, the BSG lines 315, and the TSG lines 313. The peripheral circuit 302 may comprise various types of peripheral circuits formed with the metal-oxide-semiconductor (MOS) technology. FIG. 5A is a schematic diagram of an example memory device comprising a memory cell array and a peripheral circuit according to an example of the present disclosure. The peripheral circuit 302 comprises a page buffer/sense amplifier 504, a column decoder/bit line driver 506, a row decoder/word line driver 508, a voltage generator 510, a control logic 512, a register 514, an interface 516, and a data bus 518. It is to be understood that, in some examples, an additional peripheral circuit not shown in FIG. 5A may also be comprised.

The control logic 512 may be coupled to each peripheral circuit as described above and configured to control operations of each peripheral circuit. The register 514 may be coupled to the control logic 512 and comprise a state register, a command register, and an address register for storing state information, a command operation code (OP code), and a command address for controlling the operation of each peripheral circuit. The interface 516 may be coupled to the control logic 512, and act as a control buffer to buffer control commands received from a host (not shown) and relay the control commands to the control logic 512 and buffer state information received from the control logic 512 and relay the state information to the host. The interface 516 may also be coupled to the column decoder/bit line driver 506 via the data bus 518 and act as a data I/O interface and a data buffer to buffer and relay data to the memory cell array 301 or relay or buffer data from the memory cell array 301. For example, the interface 516 here is an interface coupled with the back end interface of the memory controller described above. For example, the interface 516 may also be an interface for the memory to communicate with the memory controller.

In some implementations, the page buffer/sense amplifier 504 may be configured to read data from the memory cell array 301 and program (write) data to the memory cell array 301 according to control signals from the control logic 512. In one example, the page buffer/sense amplifier 504 may store program data (write data) to be programmed into the memory cells 306 of the memory cell array 301. In another example, the page buffer/sense amplifier 504 may perform a program verify operation to ensure that data has been properly programmed into the memory cells 306 coupled to the selected word line 318. The column decoder/bit line driver 506 may be configured to be controlled by the control logic 512 and select one or more NAND memory strings 308 by applying a bit line voltage generated from the voltage generator 510.

The row decoder/word line driver 508 may be configured to be controlled by the control logic 512, select/unselect the memory block 304 of the memory cell array 301, and select/unselect the word line 318 of the memory block 304. The row decoder/word line driver 508 may be further configured to drive the word line 318 with a word line voltage generated from the voltage generator 510. In some implementations, the row decoder/word line driver 508 may also select/unselect and drive the BSG line 315 and the TSG line 313. As described below in detail, the row decoder/word line driver 508 is configured to perform the program operation on the memory cells 306 coupled to (one or more) selected word lines 318. The voltage generator 510 may be configured to be controlled by the control logic 512 and generate a word line voltage (e.g., a read voltage, a program voltage, a pass voltage, a channel boost voltage, a verify voltage, etc.), a bit line voltage, and a source line voltage to be supplied to the memory cell array 301.

FIG. 5B is a schematic diagram of a memory controller 106 provided by an example of the present disclosure. The memory controller 106 may comprise one or more processors 522 and a memory module. The memory module comprises a cache 524. The memory controller 106 may further comprise an interface (I/F) 528 (e.g., the first interface) coupled with the host 108 and an interface (I/F) 530 (e.g., the back end interface) coupled with the memory 104. Here, the first interface is an interface coupled with the second interface of the host described above. The processor 522 may comprise an arithmetic logic unit (ALU) for performing arithmetic and logic operations. The interface 528 may receive instructions and data from the host 108, and buffer the instructions and data to the processor 522 and the cache 524, respectively. The interface 530 may separately transmit control signals and data from the processor 522 and the cache 524 to the memory 104.

Examples of the present disclosure provide a memory system. Here, regarding particular structures and compositions of the memory system, a reference may be made to related structures and compositions of the memory system 102 in FIG. 1, FIG. 2A, and FIG. 2B. For simplicity, details are no longer repeated here. The memory system comprises: a memory and a memory controller coupled with the memory, where the memory controller is configured to control the memory to achieve zoned storage by zone, where a storage space of a single zone is configured to only support sequential write. The memory controller is configured with a first interface coupled with a host and to receive a first command from the host through the first interface. The first command comprises MODE RETURN information indicating whether MEMORY MODE information of the zone needs to be returned. The memory controller is further configured to send REPORT ZONES parameter data satisfying what the MODE RETURN information indicates to the host through the first interface according to the first command.

In some implementations, the memory controller being configured to send the REPORT ZONES parameter data satisfying what the MODE RETURN information indicates to the host according to the first command in particular includes: in cases the MODE RETURN information indicates that the MEMORY MODE information of the zone needs to be returned, the REPORT ZONES parameter data sent by the memory controller to the host through the first interface comprises the MEMORY MODE information of the zone; and in cases the MODE RETURN information indicates that the MEMORY MODE information of the zone does not need to be returned, the REPORT ZONES parameter data sent by the memory controller to the host through the first interface does not comprise the MEMORY MODE information of the zone. For example, the memory controller may generate the corresponding REPORT ZONES parameter data based on the MODE RETURN information in the first command.

In some implementations, the zone is in a zone name space (ZNS). The ZNS comprises a plurality of zones. A zone is a subsection of a fixed size in the ZNS. Each zone has logical block address (LBA) section. Typically, in the ZNS, an external device (e.g., a host) provides definitions of LBAs to the memory system. For example, the host may indicate an LBA section corresponding to a first zone, an LBA section corresponding to a second zone, and so on. The memory system then maps each zone in the ZNS to a physical block in the memory. For example, the memory system may map the LBA corresponding to the first zone to a first physical block, map the LBA corresponding to the second zone to a second physical block, and so on.

In some implementations, a storage capacity of a single zone is lower than a storage capacity corresponding to the physical block of the memory. Herein, the storage capacity may refer to how much storage space the memory provides.

In some implementations, the zone name space (ZNS) may have a preset or adjustable storage capacity. The memory system supporting the zone name space (ZNS) may establish a plurality of zones such that the memory controller may control the memory to achieve zoned storage by zone. For example, the data transmitted by the host may be stored in the zones. The memory system may allocate at least one memory block or a portion of one memory block for each zone. The memory system may sequentially store the data transmitted by the host in the zones specified by the corresponding LBAs.

In the memory system supporting the ZNS, the zones in the ZNS support only sequential write and do not support random write. The zones in the ZNS may support random read and sequential read.

In some implementations, the first command comprises zoned block commands (ZBCs). For example, the first command may be a command that may be configured to acquire REPORT ZONES parameter data among the ZBCs. In a particular example, the first command may be a REPORT ZONES command among the ZBCs. Here, the first command is a command complying with a zoned universal flash storage (Zoned UFS) protocol format.

In some implementations, the REPORT ZONES command comprises MODE RETURN information indicating whether MEMORY MODE information of the zone needs to be returned.

FIG. 6 is a schematic structural diagram of a REPORT ZONES command among ZBCs provided by an example of the present disclosure. With reference to FIG. 6, the REPORT ZONES command may further comprise an OPERATION CODE field, a SERVICE ACTION field, a ZONE START LBA field, an ALLOCATION LENGTH field, a partial bit, a REPORTING OPTIONS field, a CONTROL byte, and a reserved field, etc. The various fields and information comprised in the REPORT ZONES command may be understood with reference to the ZBC specifications.

In some implementations, the MODE RETURN information is included in a reserved field that is not used in the REPORT ZONES command based on the existing ZBC specifications. In a particular example, with reference to FIG. 6, the MODE RETURN information occupies the sixth to eighth bits of the second byte in the REPORT ZONES command. In a particular example, when the MODE RETURN information is 01h, it represents that the MEMORY MODE information of the zone needs to be returned; and when the MODE RETURN information is 02h, it represents that the MEMORY MODE information of the zone does not need to be returned.

In some implementations, the MODE RETURN information may be 01h by default. In some other implementations, the MODE RETURN information may also be fixed as 01h.

In some implementations, the memory controller is configured to: in cases the MODE RETURN information is configured to indicate that the MEMORY MODE information of the zone needs to be returned, generate the REPORT ZONES parameter data comprising the MEMORY MODE information according to the first command.

In some implementations, the memory controller is configured to: when the MODE RETURN information is 01h, generate the REPORT ZONES parameter data comprising the MEMORY MODE information.

In some other implementations, the memory controller is configured to: in cases the MODE RETURN information is configured to indicate that the MEMORY MODE information of the zone does not need to be returned, generate the REPORT ZONES parameter data not comprising the MEMORY MODE information according to the first command.

In some implementations, the memory controller is configured to: when the MODE RETURN information is 02h, generate the REPORT ZONES parameter data not comprising the MEMORY MODE information. Here, the REPORT ZONES parameter data not comprising the MEMORY MODE information is the REPORT ZONES parameter data based on the existing ZBC specifications.

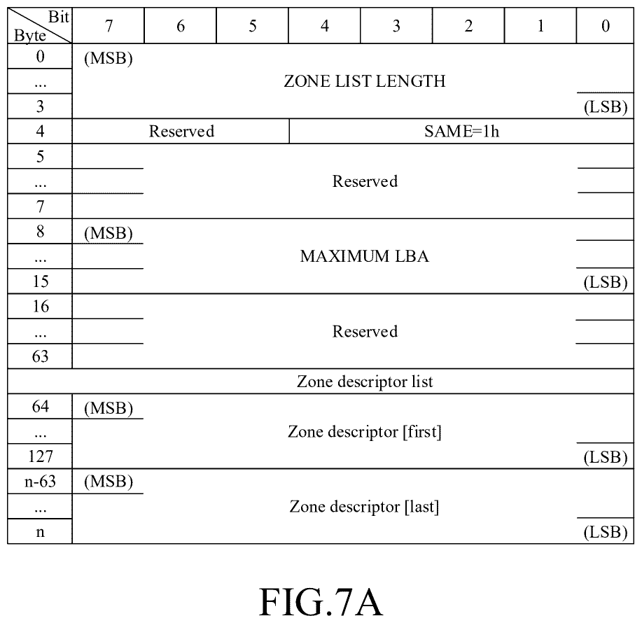

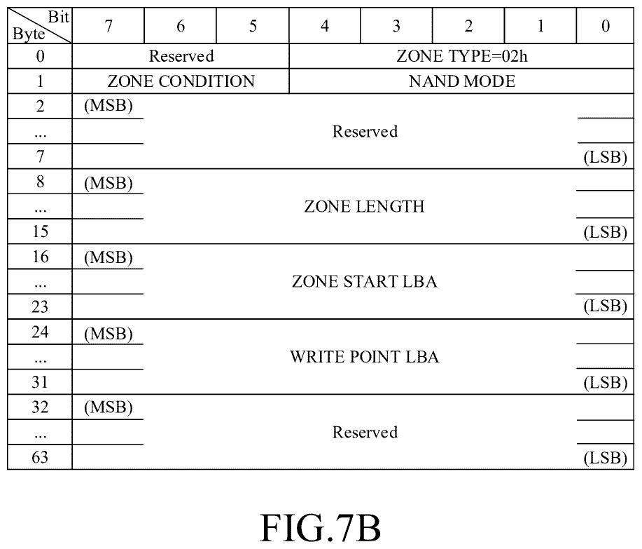

FIG. 7A is a schematic structural diagram of REPORT ZONES parameter data in ZBCs provided by an example of the present disclosure. With reference to FIG. 7A, the REPORT ZONES parameter data may comprise a zone descriptor list, a public descriptor, and a reserved field, etc.; the zone descriptor list comprises at least one zone descriptor for indicating self attributes of a corresponding zone; and the public descriptor is configured to indicate a public attribute of a plurality of zones. Where the public descriptor comprises a ZONE LIST LENGTH field, a SAME field, and a MAXIMUM LBA field as well as reserved fields, etc.

In some implementations, the MEMORY MODE (e.g., NAND MODE) information may be in a zone descriptor in the REPORT ZONES parameter data. Since each zone corresponds to one zone descriptor, the MEMORY MODE information is set in the zone descriptor of each zone such that the MEMORY MODE of each zone can be acquired based on the MEMORY MODE information in each zone descriptor.

FIG. 7B is a schematic structural diagram of a zone descriptor in REPORT ZONES parameter data provided by an example of the present disclosure. It is to be noted that FIG. 7B illustrates the zone descriptor comprising the MEMORY MODE information. With reference to FIG. 7B, the zone descriptor may further comprise a ZONE TYPE field, a ZONE CONDITION field, a ZONE LENGTH field, a ZONE START LBA field, a WRITE POINT LBA field, and reserved fields, etc. The various fields and information comprised in the REPORT ZONES parameter data and the various fields and information comprised in the zone descriptor may be understood with reference to the ZBC specifications. For example, the ZONE TYPE field may define an access type of the zone name space, and the ZONE TYPE field of 02h represents that sequential write is required in the zone name space. For another example, the SAME field may define the ZONE TYPE and the ZONE LENGTH in various zone descriptors in the zone descriptor list, and the SAME field of 1h represents that the ZONE TYPE and the ZONE LENGTH in various zone descriptors in the zone descriptor list are the same.

In some implementations, the ZONE CONDITION field may be configured to indicate a zone condition of a zone. The zone condition comprises an empty condition, an open condition, and a full condition. In the empty condition, the zone has no valid data, and the write pointer thereof is set as a starting LBA in the zone. After the zone condition is switched from the empty condition to the open condition, the zone may be written with data. In the open condition, the zone may have no valid data or may be written with valid data, and the write pointer thereof points to a certain position between ends of the starting LBA and the last LBA in the zone. The storage space corresponding to the zone may receive write data through the write command so as to be written with data. Additionally, the host may clear or erase valid data stored in a zone by resetting the zone such that the zone is reset to the empty condition. Once the storage space corresponding to a zone is fully written, the zone is switched to the full condition. In the full condition, the storage space corresponding to the zone has been fully written and cannot be opened again to receive write data.

In some implementations, the MEMORY MODE information may be contained in a reserved field that is not used in a zone descriptor in a REPORT ZONES parameter based on the existing ZBC specifications. In some implementations, the MEMORY MODE information occupies a four-bit field in the zone descriptor. In a particular example, with reference to FIG. 7B, the MEMORY MODE information occupies the first to fourth bits of the second byte in the zone descriptor.

In some implementations, the MEMORY MODE information is configured to indicate MEMORY MODE of the zone; the MEMORY MODE comprises a first MEMORY MODE and a second MEMORY MODE; when the zone is in the first MEMORY MODE, each of memory cells corresponding to the storage space of the zone can be written with N-bit data; when the zone is in the second MEMORY MODE, each of the memory cells corresponding to the storage space of the zone can be written with M-bit data; M and N are integers greater than or equal to 1; and M is greater than N.

As described above, in the NAND type memory, the memory cells may be classified into single level cells (SLC) and multi-level cells (MLC) according to the difference in memory density. Correspondingly, the first MEMORY MODE may be a single level cell (SLC) MEMORY MODE, e.g., N=1. The second MEMORY MODE may be a multi-level cell (MLC) MEMORY MODE, e.g., M is an integer greater than 1. The memory density of the first MEMORY MODE is smaller than the memory density of the second MEMORY MODE, e.g., N is less than M. The multi-level cell (MLC) MEMORY MODE may be at least one of a double-level cell MEMORY MODE, a triple-level cell (TLC) MEMORY MODE, a quad-level cell (QLC) MEMORY MODE. When M=2, the second MEMORY MODE is the double-level cell MEMORY MODE; when M=3, the second MEMORY MODE is the TLC MEMORY MODE; and when M=4, the second MEMORY MODE is the QLC MEMORY MODE.

In a particular example, when the MEMORY MODE information is 01h, it represents that the MEMORY MODE of a zone is the first MEMORY MODE; and when the MEMORY MODE information is 02h, it represents that the MEMORY MODE of the zone is the second MEMORY MODE. Where the first MEMORY MODE is the SLC MEMORY MODE, and the second MEMORY MODE is the TLC MEMORY MODE.

In some other implementations, the MEMORY MODE information may also be configured to indicate a number of bits of data stored in the memory cells included in the storage space of a zone. In a particular example, when the MEMORY MODE information is 01h, it represents that the number of bits of data stored in the memory cells included in the storage space of the zone is N; and when the MEMORY MODE information is 02h, it represents that the number of bits of data stored in the memory cells included in the storage space of the zone is M, where N=1 and M=3.

In the examples of the present disclosure, on the side of the host: by adding the MODE RETURN information to the REPORT ZONES command, the MODE RETURN information can be set based on an actual requirement, and whether to acquire the MEMORY MODE information can be selected. Correspondingly, on the side of the memory system: the REPORT ZONES parameter data satisfying what the MODE RETURN information indicates is generated based on the MODE RETURN information in the REPORT ZONES command and sent to the host. In the examples of the present disclosure, the transmission of the MEMORY MODE information between the host and the memory system can be achieved with existing ZBCs.

In the examples of the present disclosure, the MEMORY MODE information of each zone in the zone name space (ZNS) can be acquired through the REPORT ZONES command such that the MEMORY MODE of each zone can be acquired. As such, when writing data, based on cold and hot attributes of the write data, a zone with the first MEMORY MODE as the MEMORY MODE may be selectively allocated for hot data, and a zone with the second MEMORY MODE as the MEMORY MODE may be selectively allocated for non-hot data. Write data may be classified into hot data and non-hot data according to an access frequency. The non-hot data refers to data of which an access frequency is lower than a reference value set for the memory, and a predetermined storage duration thereof is relatively long. The hot data refers to data of which an access frequency is higher than the reference value set for the memory, and a predetermined storage duration thereof is relatively short. The non-hot data comprises cold data and warm data. An access frequency of the warm data is higher than that of the cold data, but lower than that of the hot data. Accordingly, the zone with the first MEMORY MODE as the MEMORY MODE may be configured to store the hot data of which the predetermined storage duration is relatively short, and the zone with the second MEMORY MODE as the MEMORY MODE may be configured to store the non-hot data of which the predetermined storage duration is relatively long. As such, based on the cold and hot attributes of the write data, the zones of the corresponding NAND mode are allocated for the write data, such that write speed and read speed of the hot data can be increased.

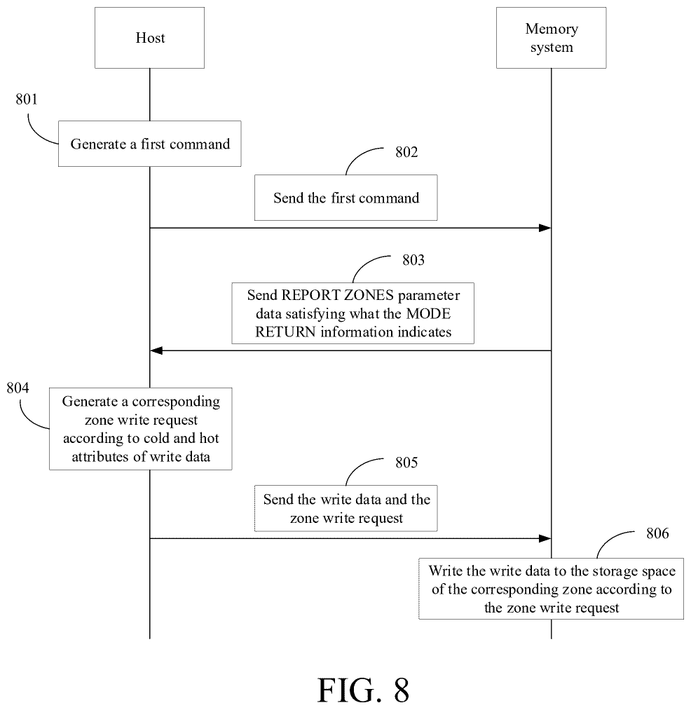

Examples of the present disclosure provide a system. Here, regarding particular structures and compositions of the system, a reference may be made to related structures and compositions of FIG. 1. For simplicity, details are no longer repeated here. FIG. 8 is a flow diagram of interaction between a memory system and a host provided by an example of the present disclosure. A working flow of the system is described with reference to FIG. 8 and FIG. 1. Not all the operations may need to be performed in the interaction between the memory system and the host, and the operations as shown in FIG. 8 may not be exhaustive, and other operations can also be performed before, after, or between any of the illustrated operations. Furthermore, some of the operations may be performed simultaneously or performed in a different order from that shown in FIG. 8. The system comprises: a memory system and a host, where the memory system comprises: a memory and a memory controller coupled with the memory, where the memory controller is configured to control the memory to achieve zoned storage by zone, where a storage space of a single zone is configured to only support sequential write; and the host comprises a host controller and a second interface coupled with the memory controller. At operation 801, the host controller is configured to generate a first command. At operation 802, the first command is sent to the memory controller through the second interface, where the first command comprises MODE RETURN information indicating whether MEMORY MODE information of the zone needs to be returned; and the memory controller is configured with a first interface coupled with the host, and the memory controller receives the first command from the host through the first interface. At operation 803, the memory controller sends REPORT ZONES parameter data satisfying what the MODE RETURN information indicates to the host through the first interface according to the first command.

In some implementations, the zone is in a zone name space (ZNS). A storage capacity of a single zone is lower than a storage capacity corresponding to the physical block of the memory. Herein, the storage capacity may refer to how much storage space the memory provides. The zone name space (ZNS) may have a preset or adjustable storage capacity. The memory system supporting the zone name space (ZNS) may establish a plurality of zones such that the memory controller may control the memory to achieve zoned storage by zone. For example, the data transmitted by the host may be stored in the zones. The memory system may allocate at least one memory block or a portion of one memory block for each zone. The memory system may sequentially store the data transmitted by the host in the zones specified by the corresponding LBAs. In the memory system supporting the ZNS, the zones in the ZNS support only sequential write and do not support random write. The zones in the ZNS may support random read and sequential read.

In some implementations, the first command comprises a REPORT ZONES command. The REPORT ZONES command may be understood with reference to FIG. 6 above, and will not be repeated here anymore.

In some implementations, the memory controller is configured to: in cases the MODE RETURN information is configured to indicate that the MEMORY MODE information of the zone needs to be returned, generate the REPORT ZONES parameter data comprising the MEMORY MODE information according to the first command. In particular, the MEMORY MODE information may be in a zone descriptor in the REPORT ZONES parameter data. The REPORT ZONES parameter data and the zone descriptor may be understood with reference to FIG. 7A and FIG. 7B, and will not be repeated here anymore. The MEMORY MODE information is configured to indicate the MEMORY MODE of a zone. The MEMORY MODE comprises a first MEMORY MODE and a second MEMORY MODE. The first MEMORY MODE may be a single level cell (SLC) MEMORY MODE. The second MEMORY MODE may be a multi-level cell (MLC) MEMORY MODE. In a particular example, the MEMORY MODE information occupies the first to the fourth bits of the second byte in the zone descriptor. When the MEMORY MODE information is 01h, it represents that the MEMORY MODE of a zone is the first MEMORY MODE; and when the MEMORY MODE information is 02h, it represents that the MEMORY MODE of the zone is the second MEMORY MODE.

In some implementations, at operation 804, the host controller is configured to generate a corresponding zone write request according to cold and hot attributes of write data. At operation 805, the host controller sends the write data and the zone write request to the memory controller through the second interface; if the write data is hot data, the zone write request is configured to indicate to write the write data into a zone where the MEMORY MODE is the first MEMORY MODE; and if the write data is non-hot data, the zone write request is configured to indicate to write the write data into a zone where the MEMORY MODE is the second MEMORY MODE. At operation 806, the memory controller is configured to write the write data into a storage space of a corresponding zone according to the zone write request.

In particular, if the write data is the hot data, the zone write request is configured to indicate to write the write data into a zone where the MEMORY MODE is the first MEMORY MODE, and at this point, the memory controller writes the write data into the storage space of the zone with the first MEMORY MODE as the MEMORY MODE according to the zone write request. If the write data is the non-hot data, the zone write request is configured to indicate to write the write data into a zone where the MEMORY MODE is the second MEMORY MODE, and at this point, the memory controller writes the write data into the storage space of the zone with the second MEMORY MODE as the MEMORY MODE according to the zone write request.

The descriptions of the above system examples are similar to the descriptions of the above memory system examples, and the above system examples have beneficial effects similar to the memory system examples. Technical details that are not disclosed in the system examples of the present disclosure can be understood with reference to the descriptions of the memory system examples of the present disclosure.

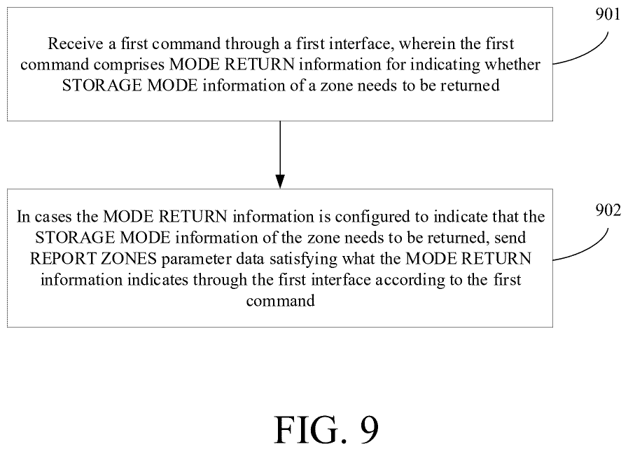

FIG. 9 is a flow diagram of an operation method of a memory system provided by an example of the present disclosure. Here, regarding particular structures and compositions of the memory system, a reference may be made to related structures and compositions of the memory system 102 in FIG. 1, FIG. 2A, and FIG. 2B. For simplicity, details are no longer repeated here. The operations as shown in FIG. 9 may not be exhaustive, and other operations can also be performed before, after, or between any of the illustrated operations. Furthermore, some of the operations may be performed simultaneously or performed in a different order from that shown in FIG. 9.

With reference to FIG. 9, at operation 901, a first command is received through the first interface, where the first command comprises MODE RETURN information for indicating whether MEMORY MODE information of a zone needs to be returned.

At operation 902, REPORT ZONES parameter data satisfying what the MODE RETURN information indicates is sent through the first interface according to the first command.

In some implementations, operation 902 comprises: in cases the MODE RETURN information is configured to indicate that the MEMORY MODE information of the zone needs to be returned, generating the REPORT ZONES parameter data comprising the MEMORY MODE information according to the first command.

In some implementations, the MEMORY MODE information is in a zone descriptor in the REPORT ZONES parameter data.

In some implementations, the MEMORY MODE information is configured to indicate MEMORY MODE of the zone; the MEMORY MODE comprises a first MEMORY MODE and a second MEMORY MODE; when the zone is in the first MEMORY MODE, each of memory cells corresponding to the storage space of the zone can be written with N-bit data; when the zone is in the second MEMORY MODE, each of the memory cells corresponding to the storage space of the zone can be written with M-bit data; M and N are integers greater than or equal to 1; and M is greater than N.

In some implementations, the REPORT ZONES parameter data comprises a zone descriptor list and a public descriptor; the zone descriptor list comprises at least one zone descriptor; and the MEMORY MODE information uses a four-bit field in the zone descriptor.

In some implementations, the first command comprises a REPORT ZONES command.

In some implementations, the zone is in a zone name space (ZNS).

The descriptions of the above operation method examples of the memory system are similar to the descriptions of the above memory system examples, and the above operation method examples of the memory system have beneficial effects similar to the memory system examples. Technical details that are not disclosed in the operation method examples of the memory system of the present disclosure can be understood with reference to the descriptions of the memory system examples of the present disclosure.

In the examples of the present disclosure, on the side of the host: by adding the MODE RETURN information to the REPORT ZONES command, the MODE RETURN information can be set based on an actual requirement, and whether to know the MEMORY MODE information can be thus selected. Correspondingly, on the side of the memory system: the REPORT ZONES parameter data satisfying what the MODE RETURN information indicates is generated based on the MODE RETURN information in the REPORT ZONES command and sent to the host. In the examples of the present disclosure, the transmission of the MEMORY MODE information between the host and the memory system can be achieved with existing ZBCs.

In the examples of the present disclosure, the MEMORY MODE information of each zone in the zone name space (ZNS) can be acquired through the REPORT ZONES command such that the MEMORY MODE of each zone can be acquired. As such, when writing data, based on cold and hot attributes of the write data, a zone with the first MEMORY MODE as the MEMORY MODE may be selectively allocated for hot data, and a zone with the second MEMORY MODE as the MEMORY MODE may be selectively allocated for non-hot data. As such, write speed and read speed of the hot data can be increased.

Examples of the present disclosure further provide a computer readable storage medium, storing a computer program thereon which, when executed, implements the operation method of a memory system in the examples of the present disclosure.

In some examples, the computer readable storage medium may be a memory such as a Ferromagnetic Random Access Memory (FRAM), a Read Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disk, or a Compact Disc Read-Only Memory (CD-ROM) and the like, or may also be various devices comprising any one or any combination of the above memories.

In some examples, the computer program can take the form of programs, software, software modules, scripts, or code, written in any form of programming language (including compiling or interpretive languages, or declarative or procedural languages), and can be deployed in any form, including being deployed as standalone programs or being deployed as modules, components, subroutines, or other units suitable for use in computing environments.

As an example, the computer program may, but does not necessarily, correspond to files in a file system, may be stored in part of a file storing other programs or data, for example, stored in one or more scripts in a Hyper Text Markup Language (HTML) document, stored in a single file dedicated for the discussed program, or stored in a plurality of cooperative files (e.g., files for storing one or more modules, subprograms or code portions).

As an example, the computer program may be deployed on one computing device for execution, or on a plurality of computing devices at one site for execution, or distributed on a plurality of computing devices for execution that locate at a plurality of sites and are interconnected through a communication network.

It is to be understood that, references to “one example” or “an example” throughout this specification mean that particular features, structures, or characteristics related to the example are included in at least one example of the present disclosure. Therefore, “in one example” or “in an example” presented everywhere throughout this specification does not necessarily refer to the same example. In addition, these specific features, structures or characteristics may be combined in one or more examples in any proper manner. It is to be understood that, in various examples of the present disclosure, sequence numbers of the above processes do not indicate an execution sequence, and an execution sequence of various processes shall be determined by functionalities and intrinsic logics thereof, and shall constitute no limitation on the implementation process of the examples of the present disclosure. The above sequence numbers of the examples of the present disclosure are only for description, and do not represent goodness and badness of the examples.

The above descriptions are merely preferred implementations of the present disclosure, and not intended to limit the scope of the present disclosure. All equivalent structure transformations made with the contents of the specification and the drawings of the present disclosure under the inventive concept of the present disclosure, or direct/indirect application to other related technical fields under the inventive concept of the present disclosure are within the scope of the present disclosure.

What is claimed is:

1. A memory system, comprising:
a memory; and
a memory controller coupled with the memory, the memory controller comprising a first interface coupled with a host and configured to:
control the memory to perform zoned storage by zone, wherein a storage space of a single zone is configured to support sequential write;
receive a first command from the host through the first interface comprising mode return information indicating whether memory mode information of a zone is to be returned to the host; and
send report zones parameter data to the host through the first interface responsive to the first command, wherein the report zones parameter data includes data specified according to the first command.

2. The memory system of claim 1, wherein the memory controller is configured to:
responsive to the mode return information indicating that the memory mode information of the zone is to be returned, generate the report zones parameter data comprising the memory mode information according to the first command.

3. The memory system of claim 2, wherein the memory mode information indicates a memory mode of the zone, the memory mode comprises a first memory mode and a second memory mode, responsive to the zone being in the first memory mode, each of memory cells corresponding to storage space of the zone can be written with N-bit data, responsive to the zone being in the second memory mode, each of the memory cells corresponding to the storage space of the zone can be written with M-bit data, M and N are integers greater than or equal to 1, and M is greater than N.

4. The memory system of claim 1, wherein the memory mode information is provided in a zone descriptor in the report zones parameter data.

5. The memory system of claim 4, wherein the report zones parameter data comprises a zone descriptor list and a public descriptor, the zone descriptor list comprises at least one zone descriptor for indicating self attributes of a corresponding zone, and the public descriptor is configured to indicate a public attribute of a plurality of zones.

6. The memory system of claim 5, wherein the memory mode information is provided in a four-bit field in the zone descriptor.

7. The memory system of claim 5, wherein the zone descriptor further comprises a zone type field, a zone condition field, a zone length field, a zone start LBA field, and a write point LBA.

8. The memory system of claim 5, wherein the public descriptor comprises a zone list length field, a same field, and a maximum LBA field.

9. The memory system of claim 1, wherein the first command comprises a report zones command.

10. The memory system of claim 1, wherein the zone is in a zone name space (ZNS).

11. A system, comprising: a memory system and a host, wherein:
the memory system comprises:
a memory; and
a memory controller coupled with the memory and comprising a first interface coupled to the host, the memory controller configured to:
control the memory to perform zoned storage, wherein a storage space of a single zone is configured to support sequential write;
receive a first command from the host through the first interface; and
send report zones parameter data to the host through the first interface according to the first command, the report zones parameter data including data specified according to the first command, wherein
the host comprises a host controller and a second interface coupled to the first interface, the host controller configured to:
generate the first command; and
send the first command to the memory controller through the second interface, the first command comprising mode return information indicating whether memory mode information of a zone needs to be returned.

12. The system of claim 11, wherein the memory controller is configured to:
responsive to the mode return information indicating that the memory mode information of the zone needs to be returned, generate the report zones parameter data comprising the memory mode information according to the first command.

13. The system of claim 12, wherein the memory mode information is provided in a zone descriptor in the report zones parameter data.

14. The system of claim 11, wherein the memory mode information indicates a memory mode of the zone, the memory mode comprises a first memory mode and a second memory mode, responsive to the zone being in the first memory mode, each of memory cells corresponding to the storage space of the zone can be written with N-bit data, responsive to the zone being in the second memory mode, each of the memory cells corresponding to the storage space of the zone can be written with M-bit data, M and N are integers greater than or equal to 1, and M is greater than N.

15. The system of claim 14, wherein the host controller is configured to:
generate a corresponding zone write request according to cold and hot attributes of write data; and
send the write data and the zone write request to the memory controller through the second interface, wherein responsive to the write data being hot data, the zone write request is indicates to write the write data into a zone where the memory mode is the first memory mode, and responsive to the write data being non-hot data, the zone write request indicates to write the write data into a zone where the memory mode is the second memory mode, and
the memory controller is configured to write the write data into a storage space of a corresponding zone according to the zone write request.

16. The system of claim 13, wherein the report zones parameter data comprises a zone descriptor list and a public descriptor, the zone descriptor list comprises at least one zone descriptor, and the memory mode information is provided in a four-bit field in the zone descriptor.

17. An operation method of a memory system, wherein the memory system comprises a memory and a memory controller coupled with the memory, the memory controller comprising a first interface coupled with a host, the method comprising:
receiving a first command through the first interface, wherein the first command comprises mode return information indicating whether memory mode information of a zone needs to be returned, the zone corresponds to a storage space of the memory, and a storage space of a single zone is configured to support sequential write; and
sending report zones parameter data through the first interface according to the first command, wherein the report zones parameter data includes data specified according to the first command.

18. The operation method according to claim 17, wherein responsive to the mode return information indicating that the memory mode information of the zone needs to be returned, sending the report zones parameter data including data specified according to the first command comprises:
generating the report zones parameter data comprising the memory mode information according to the first command.

19. The operation method of claim 18, wherein the memory mode information is provided in a zone descriptor in the report zones parameter data.

20. The operation method of claim 18, wherein the memory mode information indicates a memory mode of the zone, the memory mode comprises a first memory mode and a second memory mode, responsive to the zone being in the first memory mode, each of memory cells corresponding to storage space of the zone can be written with N-bit data, responsive to the zone being in the second memory mode, each of the memory cells corresponding to the storage space of the zone can be written with M-bit data, M and N are integers greater than or equal to 1, and M is greater than N.
